(19) United States
(12) Patent Application Publication
(10) Pub. No.: US 2012/0001864 A1
(43) Pub. Date: Jan. 5, 2012

(54) FLAT PANEL DISPLAY APPARATUS WITH TOUCH FUNCTION AND TOUCH PANEL

(75) Inventor: Tzu-Wei LIU, Hsin-Chu (TW)

(73) Assignee: AU OPTRONICS CORP., HSINCHU (TW)

(21) Appl. No.: 13/033,134

(22) Filed: Feb. 23, 2011

(30) Foreign Application Priority Data
Jun. 30, 2010 (TW) 099121599

(51) Int. Cl. G06F 3/041; G06F 3/042; G06F 3/044

(52) U.S. Cl. 345/174; 345/175; 345/173

(57) ABSTRACT

A flat panel display apparatus with touch function includes a plurality of scan lines, a plurality of data lines and a plurality of sense units. The data lines are arranged intersecting with the scan lines to divide the flat panel display apparatus into a plurality of pixel regions. The sense units are disposed into some of the pixel regions, and each of the sense units includes a sensor and a digital logic inverter. The sensor is for detecting whether the sense unit is touched and generating a corresponding sense signal. The digital logic inverter is electrically coupled to the sensor for generating an output signal according to the corresponding sense signal. The output signal is one of a first potential and a second potential, the first potential and the second potential are different from each other and respectively represent the sense unit is touched and untouched.

### BACKGROUND

1. Technical Field

The present invention relates to the touch detection field and, particularly to a flat panel display apparatus with touch function and a corresponding touch panel.

2. Description of the Related Art

With the rapid development of the science and technology, the flat panel display apparatus (such as, the liquid crystal display apparatus) has the advantages such as high image quality, little size, light weight and wide application-range, etc., it is widely applied into various consumer electronics products, such as mobile phone, notebook computer, desktop display apparatus and television, etc., and has gradually substituted the conventional cathode ray tube (CRT) display apparatus to be a main trend of the display apparatus.

The touch panel is a new human-machine interface, and is intuitional and fitted with the human nature in use. The touch panel may be integrated with the flat panel display apparatus to make the flat panel display apparatus be with the touch function, and it is an application trend for the development of the flat panel display apparatus.

Refer to FIG. 1, which is a circuit diagram of a conventional sense unit applied into a liquid crystal display apparatus with touch function. It is well known that, the liquid crystal display apparatus comprises two substrates and a liquid crystal layer sandwiched between the two substrates, and a plurality of scan lines and a plurality of data lines are disposed on one of the two substrates. The scan lines and the data lines are arranged intersecting with each other to divide the liquid crystal display apparatus into a plurality of pixel regions. For making the liquid crystal display apparatus be given with the touch function, the liquid crystal display apparatus further comprises a plurality of sense units, and the sense units are disposed into some of the pixel regions respectively.

As shown in FIG. 1, the conventional sense unit 10 applied into the liquid crystal display apparatus with touch function generally comprises three transistors and two capacitors (a 3T2C structure), that is a transistor 11, a transistor 12, a transistor 13, a reference capacitor 15 and a liquid crystal capacitor 16. A gate terminal of the transistor 11 is electrically coupled to a scan line Gₙ, and a source terminal thereof is electrically coupled to an external power source Vᵢₙᵢₜ. A gate terminal of the transistor 12 is electrically coupled to a drain terminal of the transistor 11, and a source terminal thereof is electrically coupled to the external power source Vᵢₙᵢₜ. A gate terminal of the transistor 13 is electrically coupled to a next scan line Gₙ₊₁ adjacent to the scan line Gₙ, a source terminal thereof is electrically coupled to a drain terminal of the transistor 12, and a drain terminal thereof is electrically coupled to a corresponding readout line Rₙ. The reference capacitor 15 is electrically coupled between the scan line Gₙ and the drain terminal of the transistor 11, and the liquid crystal capacitor 16 is electrically coupled between the drain terminal of the transistor 11 and a predetermined potential e.g., common potential V_{com}. The liquid crystal capacitor 16 is consisted of a pixel electrode, a common electrode and the liquid crystal layer sandwiched therebetween of the liquid crystal display apparatus, and the capacitance value of the liquid crystal capacitor 16 may be altered with the pressed degree of the sense unit 10.

When a scan signal of the scan line Gₙ is at a high potential, the transistor 11 is switched on, and a voltage of an electrical connection node (that is the gate terminal of the transistor 12) between the reference capacitor 15 and the liquid crystal capacitor 16 is initialized to be the voltage of the external power source Vᵢₙᵢₜ. When the scan signal of the scan line Gₙ is at a low potential, the transistor 11 is switched off, and the voltage of the gate terminal of the transistor 12 is V_{gate}=Vᵢₙᵢₜ−ΔV*C_{ref}/(C_{ref}+C_{lc}+Cₚ). ΔV is the voltage difference between the high potential and the low potential of the scan signal of the scan line Gₙ, C_{ref} is a capacitance value of the reference capacitor, C_{lc} is a capacitance value of the liquid crystal capacitor and is altered with the pressed degree of the sense unit 10 of the liquid crystal display apparatus, and Cₚ is a capacitance value of a related parasitic capacitor (not shown). In addition, the transistor 12 is partially switched on at this moment, and the voltage V_{gate} of the gate terminal thereof determines the switching-on degree of the transistor 12. Furthermore, the drain terminal of the transistor 12 generates a corresponding voltage according to the voltage V_{gate} of the gate terminal thereof. When the scan signal of the scan line Gₙ₊₁ is at the high potential, the transistor 13 is switched on, and the voltage of the drain terminal of the transistor 12 is read out to the readout unit (not shown) through the readout line Rₙ as the sense signal. The readout unit determines whether the sense unit 10 is touched according to the voltage of the drain terminal of the transistor 12.

However, the sense signal outputted from the sense unit 10 is an analog signal, and is prone to be influenced by various factors such as the environment etc., so that the related determining result consequently. That is, the output result of the conventional sense unit 10 is not accurate, and it is difficult to determine whether the sense unit 10 is touched. Furthermore, the sense signal outputted from the conventional sense unit 10 needs to be further processed by the readout unit before determining whether the sense unit 10 is touched, thus it must employ the readout unit with complex circuit structure.

### SUMMARY

Therefore, an objective of the present invention is to provide a flat panel display apparatus with touch function, which can simply and accurately determine a related touch operation.

Another objective of the present invention is also to provide a touch panel, which can simply and accurately determine a related touch operation.

The present invention provides a flat panel display apparatus with touch function, which comprises a plurality of scan lines, a plurality of data lines and a plurality of sense units. The data lines are arranged intersecting with the scan lines to divide the flat panel display apparatus into a plurality of pixel regions. The sense units are disposed into some of the pixel regions, and each of the sense units comprises a sensor and a digital logic inverter. The sensor is configured for detecting whether the sense unit is touched and generating a corresponding sense signal. The digital logic inverter is electrically coupled to the sensor for generating an output signal according to the corresponding sense signal. The output signal is one of a first potential and a second potential, the first potential and the second potential are different from each other and respectively represent the sense unit is touched and untouched.

The present invention also provides a touch panel, which comprises a plurality of scan lines and a plurality of sense units. Each of the sense units comprises a sensor and a digital logic inverter. The sensor is configured for detecting whether the sense unit is touched and generating a corresponding sense signal. The digital logic inverter is electrically coupled to the sensor for generating an output signal according to the corresponding sense signal. The output signal is one of a first potential and a second potential, the first potential and the second potential are different from each other and respectively represent the sense unit is touched and untouched.

In an exemplary embodiment of the present invention, the digital logic inverter comprises a first transistor, a second transistor and a capacitor. The first transistor comprises a first control terminal, a first route terminal and a second route terminal. The first control terminal is electrically coupled to a first reference voltage, and the first route terminal is electrically coupled to the first reference voltage. The second transistor comprises a second control terminal, a third route terminal and a fourth route terminal. The second control terminal is electrically coupled to the sensor for receiving the corresponding sense signal generated by the sensor, the third route terminal is electrically coupled to a second reference voltage, and the fourth route terminal is electrically coupled to the second route terminal. An electrical connection node between the second route terminal and the fourth route terminal is used as an output terminal of the digital logic inverter for outputting the output signal. The capacitor is electrically coupled between the output terminal of the digital logic inverter and a predetermined potential. The first transistor has a same conductive type as the second transistor, and the first reference voltage is different from the second reference voltage.

In another exemplary embodiment of the present invention, the digital logic inverter comprises a first transistor and a second transistor. The first transistor comprises a first control terminal, a first route terminal and a second route terminal. The first control terminal is electrically coupled to the sensor, and the first route terminal is electrically coupled to a first reference voltage. The second transistor comprises a second control terminal, a third route terminal and a fourth route terminal. The second control terminal is electrically coupled to the sensor, the third route terminal is electrically coupled to a second reference voltage, and the fourth route terminal is electrically coupled to the second route terminal. An electrical connection node between the second route terminal and the fourth route terminal is used as an output terminal of the digital logic inverter for outputting the output signal. The first transistor has a conductive type different from that of the second transistor, and the first reference voltage is different from the second reference voltage.

In an exemplary embodiment of the present invention, the sensor is a press-type sensor. In detail, the press-type sensor comprises a transistor, a reference capacitor and a press capacitor. The transistor comprises a control terminal, a first route terminal and a second route terminal. The control terminal is electrically coupled to a corresponding one of the scan lines, and the first route terminal is electrically coupled to a next scan line adjacent to the corresponding scan line. The reference capacitor is electrically coupled between the second route terminal and the next scan line adjacent to the corresponding scan line. The press capacitor is electrically coupled between the second route terminal and the predetermined potential and further electrically coupled to the reference capacitor. An electrical connection node between the reference capacitor and the press capacitor is used as an output terminal of the sensor for outputting the corresponding sense signal. Preferably, the flat panel display apparatus is a liquid crystal display apparatus, and the press capacitor comprises a corresponding pixel electrode, a common electrode and a liquid crystal layer sandwiched therebetween of the liquid crystal display apparatus.

In another exemplary embodiment of the present invention, the sensor is a light-sensitive sensor. In detail, the light-sensitive sensor comprises a transistor and a capacitor. The transistor comprises a control terminal, a first route terminal and a second route terminal. The control terminal electrically coupled to a corresponding one of the scan lines, and the first route terminal electrically coupled to a reference voltage. The capacitor is electrically coupled between the second route terminal and the predetermined potential. An electrical connection node between the capacitor and the second route terminal is used as an output terminal of the sensor for outputting the corresponding sense signal.

The sense unit applied into the flat panel display apparatus and the touch panel of the present invention employs the sensor to detect whether the sense unit is touched and generate the corresponding sense signal, and further employs the digital logic inverter to generate the corresponding digital logic output signal according to the sense signal, for accurately determining whether the sense unit is touched or not. In addition, since the output signal of the digital logic inverter is the digital logic signal, there does not need a readout circuit with complex circuit structure to read out and judge the logic output signal.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 is a circuit diagram of a conventional sense unit applied into a liquid crystal display apparatus with touch function.

FIG. 2 is a schematic circuit block diagram of a sense unit applied into a flat panel display apparatus with touch function in accordance with a first exemplary embodiment of the present invention.

FIG. 3 is a detailed circuit diagram of the sense unit as shown in FIG. 2.

FIG. 4 is a detailed circuit diagram of a sense unit applied into a flat panel display apparatus with touch function in accordance with a second exemplary embodiment of the present invention.

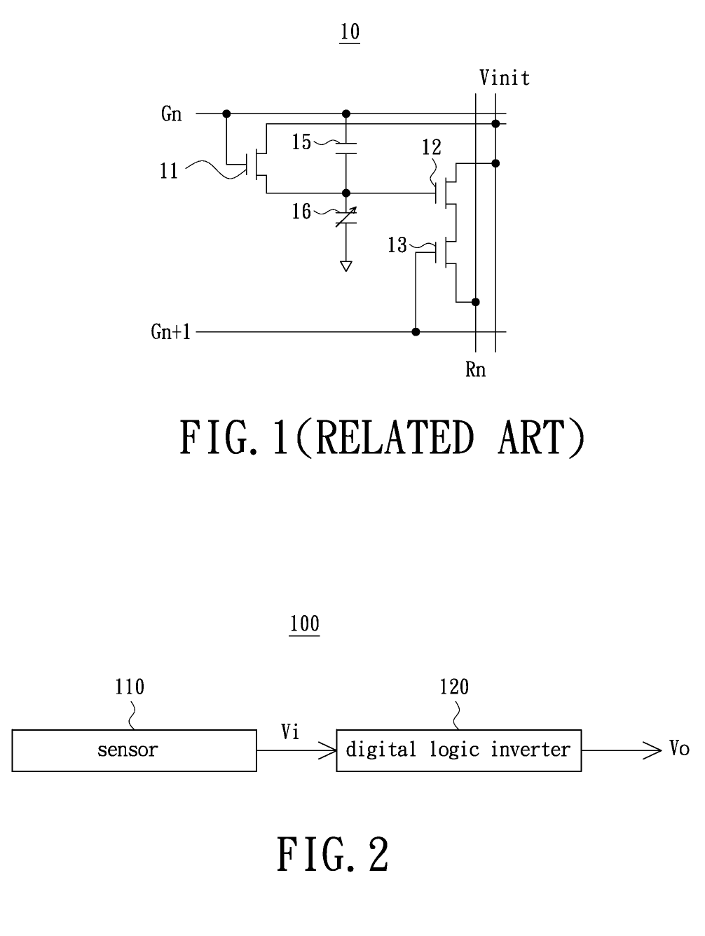

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

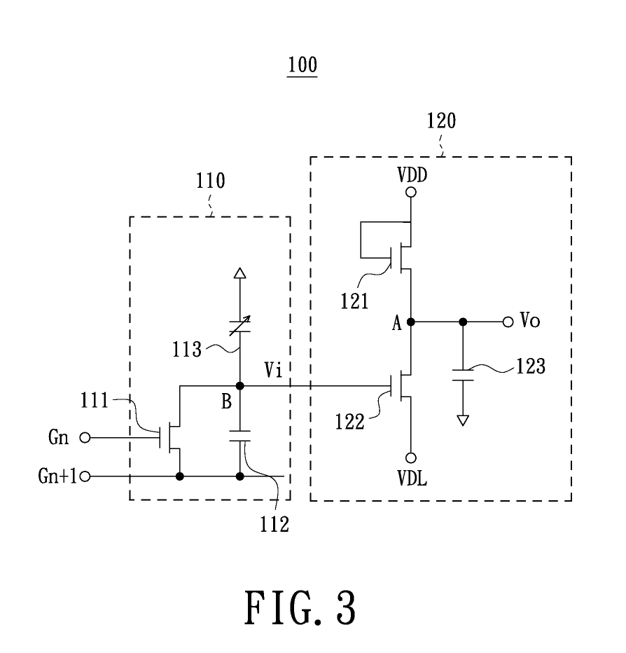

Refer to FIGS. 2 and 3, FIG. 2 is a circuit block diagram of a sense unit applied into a flat panel display apparatus with touch function in accordance with a first exemplary embodiment of the present invention, and FIG. 3 is a detailed circuit diagram of the sense unit as shown in FIG. 2. The flat panel display apparatus of the exemplary embodiment of the present invention may be a liquid crystal display apparatus which is similar with the conventional liquid crystal display apparatus, except that the sense unit has a different structure. Therefore, the following exemplary embodiment will primarily describe the sense unit, and not describe the other related structures of the flat panel display apparatus.

As shown in FIG. 2, the sense unit 100 comprises a sensor 110 and a digital logic inverter 120. The sensor 110 is configured (i.e., structured and arranged) for detecting whether the sense unit 100 is touched or not and generating a corresponding sense signal Vᵢ. The digital logic inverter 120 is electrically coupled to the sensor 110 and configured for generating a corresponding output signal Vₒ according to the corresponding sense signal Vᵢ. The output signal Vₒ is consisted of a logic high potential and a logic low potential to represent the sense unit 100 is touched and untouched respectively.

In detail, as shown in FIG. 3, the digital logic inverter 120 comprises a first transistor 121, a second transistor 122 and a capacitor 123. The first transistor 121 has a same conductive type as the second transistor 122, for example, they are both n-type transistors. A gate terminal (that is a first control terminal) of the first transistor 121 is electrically coupled to a first reference voltage, such as a high potential reference voltage VDD, a source terminal (that is a first route terminal) thereof also is electrically coupled to the high potential reference voltage V_{DD}, and a drain terminal (that is a second route terminal) thereof is electrically coupled to a drain terminal (that is a four route terminal) of the second transistor 122. A gate terminal (that is a second route terminal) of the second transistor 122 is electrically coupled to the sensor 110 for receiving the sense signal Vᵢ generated by the sensor 110, and a source terminal (that is a third route terminal) thereof is electrically coupled to a second reference voltage, such as a low potential reference voltage V_{DL}. The first reference voltage is different from the second reference voltage. In addition, an electrical connection node A between the drain terminal of the first transistor 121 and the drain terminal of the second transistor 122 is used as an output terminal of the digital logic inverter 120 and configured for providing the output signal Vₒ. The capacitor 123 is electrically coupled between the output terminal of the digital logic inverter 120 and the predetermined potential e.g., common potential.

In the exemplary embodiment, the sensor 110 is a press-type sensor and comprises a third transistor 111, a reference capacitor 112 and a press capacitor 113. The third transistor 111 has a same conductive type as both the first transistor 121 and the second transistor 122, that is also is an n-type transistor. In detail, a gate terminal (that is a third control terminal) of the third transistor 111 is electrically coupled to a corresponding scan line Gₙ, a source terminal (that is a fifth route terminal) thereof is electrically coupled to a next scan line Gₙ₊₁ adjacent to the scan line Gₙ, and a drain terminal (that is a sixth route terminal) thereof is electrically coupled to an electrical connection node between the reference capacitor 112 and the press capacitor 113. The reference capacitor 112 is electrically coupled between the drain terminal of the third transistor 111 and the scan line Gₙ₊₁, and the press capacitor 113 is electrically coupled between the drain terminal of the third transistor 111 and the predetermined potential. Furthermore, the electrical connection node B between the reference capacitor 112 and the press capacitor 113 is used as an output terminal of the sensor 110 and configured for outputting the corresponding sense signal Vᵢ generated by the sensor 110.

Preferably, the press capacitor 113 is a liquid crystal capacitor generated by the detailed structures of the liquid crystal display apparatus, and is consisted of a corresponding pixel electrode, a common electrode, and a liquid crystal layer sandwiched therebetween. When the sense unit 100 is pressed, the capacitance value of the press capacitor 113 is altered, and the capacitance value of the press capacitor 113 is increased with the increase of the press force applied thereto.

It is well known that, the flat panel display apparatus transmits the scan signals to the scan lines in sequence. That is, the scan signals in the scan lines each is consisted of a logic high potential and a logic low potential. Generally, the logic high potential is a certain reference voltage V, and the logic low potential is 0 voltage. In this condition, the voltage difference between the logic high potential and the logic low potential is ΔV.

When the scan signal of the scan line Gₙ is at the logic high potential, the third transistor 111 is switched on, and the scan signal of the scan line Gₙ₊₁ is at the logic low potential. Therefore, the switched-on third transistor 111 can initialize the voltage of the node B between the reference capacitor 112 and the press capacitor 113 to be the logic low potential.

When the scan signal of the scan line Gₙ is at the logic low potential and the scan signal of the scan line Gₙ₊₁ is at the logic high potential, the third transistor 111 is switched off, and the voltage of the electrical connection node B is increased with suddenly rising the voltage of the scan line Gₙ₊₁ because of the capacitance coupling effect. In detail, the voltage of the electrical connection node B is Vᵢ=ΔV*C_{lc}/(C_{ref}+C_{lc})=ΔV/(1+C_{ref}/C_{lc}), wherein C_{ref} is the capacitance value of the reference capacitor 112, and C_{lc} is the capacitance value of the press capacitor 113.

The reference capacitor 112 and the press capacitor 113 may be designed to be that the voltage Vᵢ of the electrical connection node B cannot switch on the second transistor 122 of the digital logic inverter 120 when the press capacitor 113 is not pressed. When the press capacitor 113 is pressed, the capacitance value C_{lc} of the press capacitor 113 is increased such that the voltage Vᵢ of the electrical connection node B is increased therewith until it is enough to switch on the second transistor 122.

That is, when the sense unit 100 is not pressed, the second transistor 122 is switched off. At this moment, since the gate terminal of the first transistor 121 is electrically coupled to the high potential reference voltage V_{DD}, the first transistor 121 is switched on and the high potential reference voltage V_{DD} charges the capacitor 123, such that the output voltage Vₒ of the output terminal of the digital logic inverter 120 is the logic high potential. When the sense unit 100 is pressed until a certain press degree, the second transistor 122 of the digital logic inverter 120 is switched on. At this moment, although the first transistor 121 is still switched on and the high potential reference voltage V_{DD} still charges the capacitor 123, the second transistor 122 is switched on and the low potential reference voltage V_{EL} discharges the capacitor 123, such that output voltage Vo of the output terminal of the digital logic inverter 120 is the logic low potential.

Therefore, the sense unit 100 of the exemplary embodiment can convert the sense signal Vᵢ generated by the sensor 110 into the digital logic signal Vₒ by the digital logic inverter 120, for determining whether the sense unit 100 is touched or not. Accordingly, since the output signal Vₒ of the sense unit 100 of the exemplary embodiment is the digital logic signal, it is accurate and easily to be determined. Furthermore, it does not need a readout circuit with complex circuit structure to read out and judge the output signal Vₒ.

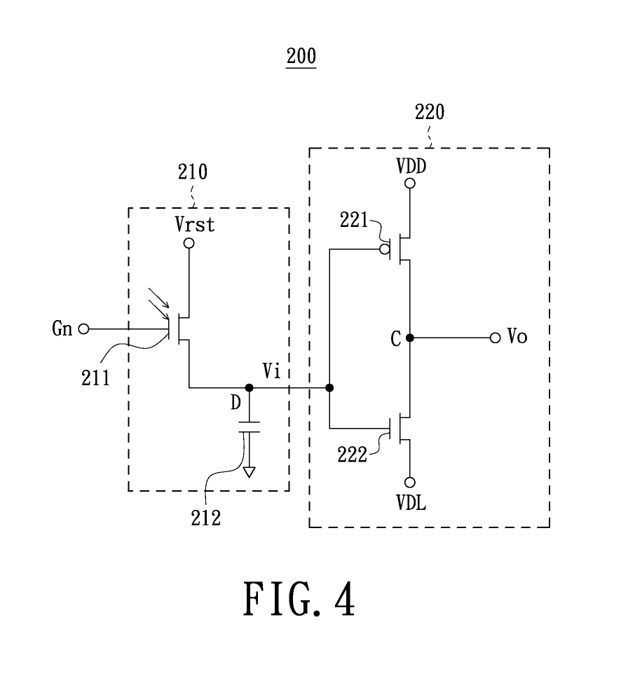

Refer to FIG. 4, which is a detailed circuit diagram of a sense unit in accordance with a second exemplary embodiment of the present invention. As shown in FIG. 4, the sense unit 200 comprises a sensor 210 and a digital logic inverter 220.

The digital logic inverter 220 comprises a first transistor 221 and a second transistor 222. The first transistor 221 has a conductive type different from that of the second transistor 222. For example, the first transistor 221 is a p-type transistor while the second transistor 222 is an n-type transistor. A gate terminal (that is a first control terminal) of the first transistor 221 and a gate terminal (that is a second control terminal) of the second transistor 222 are both electrically coupled to an output terminal of the sensor 210 for receiving a corresponding sense signal Vᵢ generated by the sensor 210. A source terminal (that is a first route terminal) of the first transistor 221 is electrically coupled to a high potential reference voltage V_{DD}, and a source terminal (that is a third route terminal) of the second transistor 222 is electrically coupled to a low potential reference voltage V_{DL}. Furthermore, a drain terminal (that is a second route terminal) of the first transistor 221 is electrically coupled to a drain terminal (that is a fourth route terminal) of the second transistor 222, and an electrical connection node C therebetween is used as an output terminal of the digital logic inverter 220 to generate an output signal Vₒ.

In addition, the sensor 210 of the exemplary embodiment is a light-sensitive sensor. In detail, the sensor 210 comprises a light-sensitive transistor 211 and a capacitor 212. A gate terminal (that is a third control terminal) of the light-sensitive transistor 211 is electrically coupled to a corresponding scan line Gₙ, and a source terminal (that is a fifth route terminal) thereof is electrically coupled to a reference voltage Vᵣₛₜ. The capacitor 212 is electrically coupled between a drain terminal (that is a sixth route terminal) of the light-sensitive transistor 211 and the predetermined potential. Furthermore, an electrical connection node B between the drain terminal of the light-sensitive transistor 211 and the capacitor 212 is used as the output terminal of the sensor 210 to output the sense signal Vᵢ generated by the sensor 210.

When the sense unit 200 is un-touched, an illumination intensity received by the light-sensitive transistor 211 is largest, and a negative voltage generated on the gate terminal of the light-sensitive transistor 211 by the illumination is largest correspondingly. When the scan signal of the scan line Gₙ is at the logic high potential, since the voltage generated on the gate terminal of the light-sensitive transistor 211 by the illumination has a polarity opposite to the scan signal at the logic high potential, at this moment, the voltage of the gate terminal of the light-sensitive transistor 211 is low and the light-sensitive transistor 211 is switched off. At this moment, the sense signal Vᵢ generated by the light-sensitive sensor 210 is low, the first transistor 221 of the digital logic inverter 220 is switched on while the second transistor 222 is switched off. Thus, the output voltage Vₒ outputted from the digital logic inverter 220 is the high potential reference voltage V_{DD}, that is the logic high potential.

When the sense unit 200 is touched, the illumination intensity received by the light-sensitive transistor 211 is decreased, and the negative voltage generated on the gate terminal of the light-sensitive transistor 211 by the illumination is also decreased. In this condition, when the scan signal of the scan line Gₙ is the logic high potential, the voltage of the gate terminal of the light-sensitive transistor is high enough to completely or partially switch on the light-sensitive transistor 211. When the light-sensitive transistor 211 is at least partially switched on, the reference voltage Vᵣₛₜ charges the capacitor 212. If the sense unit 200 is blocked off more illumination, the switched-on degree of the light-sensitive transistor 211 is more larger, and the sense signal Vᵢ generated by the light-sensitive transistor 211 is more larger correspondingly. That is, at this moment, the sense signal Vᵢ generated by the light-sensitive transistor 210 is high, the first transistor 221 of the digital logic inverter 220 is switched off while the second transistor 222 is switched on. The output voltage Vₒ outputted from the digital logic inverter 220 is the low potential reference voltage V_{DL}, that is the logic low potential.

Therefore, the sense unit 200 of the present exemplary embodiment can convert the sense signal Vᵢ generated by the light-sensitive sensor 210 into the logic signal Vₒ by the digital logic inverter 220, to accurately determine whether the sense unit 200 is touched or not.

It is understood for persons skilled in the art that, the present invention can cooperate the light-sensitive sensor 210 disclosed in the second exemplary embodiment of the present invention with the digital logic inverter 120 disclosed in the first exemplary embodiment to form a sense unit. Similarly, the present invention may also cooperate the press-type sensor 110 disclosed in the first exemplary embodiment with the digital logic inverter 220 disclosed in the second exemplary embodiment to form another sense unit.

Furthermore, it is also understood for persons skilled in the art that, the sense units disclosed in the present invention may be directly applied into the flat panel display apparatus, such that the flat panel display apparatus is endowed with touch function. Of course, the sense units disclosed in the present invention also may be applied into a panel with a plurality of scan lines to form a touch panel.

In summary, such sense unit applied into the flat panel display apparatus and the touch panel of the present invention employs the sensor to detect whether the sense unit is touched or not and generate the corresponding sense signal, and further employs the digital logic inverter to generate the corresponding digital logic output signal according to the sense signal, for accurately determining whether the sense unit is touched or not. In addition, since the output signal of the digital logic inverter is the digital logic signal, it does not need a readout circuit with complex circuit structure to read out and judge the logic output signal.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A flat panel display apparatus with touch function, comprising:
a plurality of scan lines;
a plurality of data lines intersecting with the scan lines to divide the flat panel display apparatus into a plurality of pixel regions; and
a plurality of sense units disposed into some of the pixel regions, and each of the sense units comprising:
a sensor configured for detecting whether the sense unit is touched or not and generating a corresponding sense signal; and
a digital logic inverter electrically coupled to the sensor for generating an output signal according to the corresponding sense signal, wherein the output signal is one of a first potential and a second potential, the first potential and the second potential are different from each other and respectively represent the sense unit is touched and un-touched.

2. The flat panel display apparatus according to claim 1, wherein the digital logic inverter comprises:
a first transistor, comprising:
a first control terminal electrically coupled to a first reference voltage;
a first route terminal electrically coupled to the first reference voltage; and
a second route terminal;
a second transistor, comprising:
a second control terminal electrically coupled to the sensor for receiving the corresponding sense signal generated by the sensor;
a third route terminal electrically coupled to a second reference voltage; and
a fourth route terminal electrically coupled to the second route terminal, and a node between the second route terminal and the fourth route terminal being used as an output terminal of the digital logic inverter for outputting the output signal; and
a capacitor electrically coupled between the output terminal of the digital logic inverter and a predetermined potential;
wherein the first transistor and the second transistor have a same conductive type, and the first reference voltage and the second reference voltage are different from each other.

3. The flat panel display apparatus according to claim 1, wherein the digital logic inverter comprises:
a first transistor, comprising:
a first control terminal electrically coupled to the sensor;
a first route terminal electrically coupled to a first reference voltage; and
a second route terminal; and
a second transistor, comprising:
a second control terminal electrically coupled to the sensor;
a third route terminal electrically coupled to a second reference voltage; and
a fourth route terminal electrically coupled to the second route terminal, and a node between the second route terminal and the fourth route terminal being used as an output terminal of the digital logic inverter for outputting the output signal;
wherein the first transistor has a conductive type different from that of the second transistor, and the first reference voltage is different from the second reference voltage.

4. The flat panel display apparatus according to claim 1, wherein the sensor is a press-type sensor.

5. The flat panel display apparatus according to claim 4, wherein the press-type sensor comprises:
a transistor, comprising:
a control terminal electrically coupled to a corresponding one of the scan lines;
a first route terminal electrically coupled to a next scan line adjacent to the corresponding scan line; and
a second route terminal;
a reference capacitor, electrically coupled between the second route terminal and the next scan line adjacent to the corresponding scan line; and
a press capacitor, electrically coupled between the second route and the predetermined potential and further electrically coupled to the reference capacitor, and a node between the reference capacitor and the press capacitor being used as an output terminal of the sensor for outputting the corresponding sense signal.

6. The flat panel display apparatus according to claim 5, wherein the flat panel display apparatus is a liquid crystal display apparatus, and the press capacitor is constituted by a corresponding pixel electrode, a common electrode and a liquid crystal layer sandwiched therebetween of the liquid crystal display apparatus.

7. The flat panel display apparatus according to claim 1, wherein the sensor is a light-sensitive sensor.

8. The flat panel display apparatus according to claim 7, wherein the light-sensitive sensor comprises:
a transistor, comprising:
a control terminal electrically coupled to a corresponding one of the scan lines;
a first route terminal electrically coupled to a reference voltage;
and
a second route terminal; and
a capacitor, electrically coupled between the second route terminal and the predetermined potential, and a node between the capacitor and the second route terminal being used as an output terminal of the sensor for outputting the corresponding sense signal.

9. A touch panel, comprising:
a plurality of scan lines; and
a plurality of sense units, and each of the sense units comprising:
a sensor configured for detecting whether the sense unit is touched or not and generating a corresponding sense signal; and
a digital logic inverter electrically coupled to the sensor for generating an output signal according to the corresponding sense signal, wherein the output signal is one of a first potential and a second potential, the first potential and the second potential are different from each other and respectively represent the sense unit is touched and un-touched.

10. The touch panel according to claim 9, wherein the digital logic inverter comprises:
a first transistor, comprising:
a first control terminal electrically coupled to a first reference voltage;
a first route terminal electrically coupled to the first reference voltage; and
a second route terminal;
a second transistor, comprising:
a second control terminal electrically coupled to the sensor for receiving the corresponding sense signal generated by the sensor;
a third route terminal electrically coupled to a second reference voltage; and
a fourth route terminal electrically coupled to the second route terminal, and a node between the second route terminal and the fourth route terminal being used as an output terminal of the digital logic inverter for outputting the output signal; and
a capacitor, electrically coupled between the output terminal of the digital logic inverter and a predetermined potential;
wherein the first transistor has a same conductive type as the second transistor, and the first reference voltage is different from the second reference voltage.

11. The touch panel according to claim 9, wherein the digital logic inverter comprises:
a first transistor, comprising:
a first control terminal electrically coupled to the sensor;
a first route terminal electrically coupled to a first reference voltage; and
a second route terminal; and
a second transistor, comprising:
a second control terminal electrically coupled to the sensor;
a third route terminal electrically coupled to a second reference voltage; and
a fourth route terminal electrically coupled to the second route terminal, and a node between the second route terminal and the fourth route terminal being used as an output terminal of the digital logic inverter for outputting the output signal;
wherein the first transistor has a conductive type different from that of the second transistor, and the first reference voltage is different from the second reference voltage.

12. The touch panel according to claim 9, wherein the sensor is a press-type sensor.

13. The touch panel according to claim 4, wherein the press-type sensor comprises:
a transistor, comprising:
a control terminal electrically coupled to a corresponding one of the scan lines;
a first route terminal electrically coupled to a next scan line adjacent to the corresponding scan line; and
a second route terminal;
a reference capacitor, electrically coupled between the second route terminal and the next scan line adjacent to the corresponding scan line; and
a press capacitor, electrically coupled between the second route terminal and the predetermined potential and further electrically coupled to the reference capacitor, and a node between the reference capacitor and the press capacitor being used as an output terminal of the sensor for outputting the corresponding sense signal.

14. The touch panel according to claim 9, wherein the sensor is a light-sensitive sensor.

15. The touch panel according to claim 14, wherein the light-sensitive sensor comprises:
a transistor, comprising:
a control terminal electrically coupled to a corresponding one of the scan lines;
a first route terminal electrically coupled to a reference voltage;
and
a second route terminal; and
a capacitor, electrically coupled between the second route terminal and the predetermined potential, and a node between the capacitor and the second route terminal being used as an output terminal of the sensor for outputting the corresponding sense signal.
